(19) United States
(12) Patent Application Publication
(10) Pub. No.: US 2018/0320335 A1
(43) Pub. Date: Nov. 8, 2018

(54) OFFSHORE WIND POWER FOUNDATION WITH IMPROVED WATER-TIGHTNESS AND CONSTRUCTION METHOD THEREOF

(71) Applicant: ACE ENC Inc., Gyeonggi-do (KR)

(72) Inventors: Hye Kwan JEON, Gyeonggi-do (KR); Gee Seung PARK, Seoul (KR)

(73) Assignee: ACE ENC Inc., Gyeonggi-do (KR)

(21) Appl. No.: 15/912,573

(22) Filed: Mar. 6, 2018

(30) Foreign Application Priority Data
May 8, 2017 (KR) 10-2017-0057253

(51) Int. Cl. E02D 27/42; F03D 13/25

(52) U.S. Cl. CPC E02D 27/425; E02B 2017/0039; F03D 13/25

(57) ABSTRACT

An offshore wind power foundation with improved water-tightness and a construction method thereof are provided. The offshore wind power foundation is configured such that a bonding material is injected into a space between a pile and a leg using a precast cap member to integrate the leg and the pile, and includes a precast cap member including a precasting housing, a bonding material rotation-injection port, and an elastic spring.

### CROSS-REFERENCE TO RELATED APPLICATION

This application claims priority to and the benefit of Korean Patent Application No. 2017-0057253, filed on May 8, 2017, the disclosure of which is incorporated herein by reference in its entirety.

### BACKGROUND

### 1. Field of the Invention

The present invention relates to an offshore wind power foundation with improved water-tightness and a construction method thereof, and more specifically, to an offshore wind power foundation with improved water-tightness which is advantageous in constructability and quality management due to structural integrity and water-tightness required to inject a bonding material being secured when an offshore wind foundation is fixed to the seabed ground using a pile, and a construction method thereof.

### 2. Discussion of Related Art

FIG. 1A shows a construction view of a conventional offshore wind power generator concrete foundation structure.

The concrete foundation structure, which is installed on the seabed ground to support an upper structure including a nacelle for an offshore wind power generator, a blade, and a tower, includes:

a concrete structure 10 including a leg flange 11 having a plurality of shaft holes disposed at an outer circumference of a block-type body at regular intervals;

steel piles 12 inserted into and passing through the shaft holes to support the concrete structure 10 in a state in which the concrete structure 10 is fixed to the seabed ground, and installed in the seabed ground; and

a connector member 30 for dissimilar material synthesis reinforcement interposed between the shaft holes and the steel pile to form a synthesized structure of the steel pile and the concrete structure.

The connector member 30 includes steel sleeves 31 installed in the shaft holes to allow the steel piles to pass therethrough, and a grouting material 32 injected between the steel sleeve and the steel pile.

In this case, a welding bid 31B and a stud 31S are formed between the grouting materials 32 injected into a space between the steel sleeve and the steel pile to ensure synthesis performance.

In this case, since the injection of the grouting material 32 is performed under water, workability is degraded when the grouting material 32 is injected into a space between the steel sleeve and the steel pile. Thus, defects inevitably occur when quality control is not managed.

FIG. 1B shows a unit for injecting the grouting material 32 of the conventional offshore wind power generator concrete foundation structure.

That is, it can be seen that the guide pipe cap 40 including an injection hole 41 and a discharge hole 42 allows the grouting material 32 to be press-fitted into the guide pipe cap 40 and inserted into the ground under a support structure foundation A.

In this case, when water-tightness is not secured when the guide pipe cap 40 is fixed to an upper surface of the support structure foundation A by an anchor bolt, a problem in which the grouting material 32 and seawater are mixed is caused.

Therefore, it is very important for the grouting material (a bonding material) to be press-fitted into a watertight space when the conventional offshore wind power foundation is fixed to the seabed ground using a pile, but since the press-fitting is performed under water, it is practically difficult for quality control to be managed, and a technology in which both structural integration of the pile, the guide pipe cap, and the offshore wind power foundation and water-tightness are secured is required.

(Patent Document 1) Korean patent No. 10-1595490 (Title: Support Concrete Structure Construction Method, Published on Feb. 18, 2016)
(Patent Document 2) Korean laid open patent No. 10-2016-0143599 (Title: Hybrid Type Concrete Foundation of Offshore Wind Turbine using Composite of Concrete and Steel Sleeve and Fabrication Method Thereof, Published on Dec. 14, 2016)

### SUMMARY OF THE INVENTION

The present invention is directed to an offshore wind power foundation with improved water-tightness allowing quality control thereof to be easily managed by allowing a pile and a bonding material between a leg of the offshore wind power foundation and the pile to be processed under a water-tight condition when the offshore wind power foundation is fixed to the seabed ground using the pile, and a construction method thereof.

Further, the present invention is also directed to an offshore wind power foundation with improved water-tightness allowing stability of the offshore wind power foundation to be increased by securing water-tightness and applying pre-stress to a head of a pile from a leg of the wind power foundation such that a bonding force of the offshore wind power foundation and the pile is increased, and a construction method thereof

According to an aspect of the present invention, there is provided an offshore wind power foundation with improved water-tightness configured such that a bonding material (300) is injected into a space between a pile and a leg using a precast cap member (200) to integrate the leg (120) and the pile (110), wherein the precast cap member (200) includes a precast housing (210) including flanges (212) fixed to an upper surface of the leg (120) by a first front expanding anchor (220a) and a housing body (211) formed between the flanges, a bonding material rotation injection port (230) which is an inner pipe (231) having a rotating blade (232) inserted into an outer pipe (233) and formed at an outer circumferential surface thereof, wherein the bonding material (300) is rotation-injected into a space between the pile (110) and the leg (120) through the injection port (213) formed in the housing body (211) via the rotating blade (232), and an elastic spring unit (240) configured to extend an elastic spring (241) installed between the housing body (211) of the precast housing (210) and an upper surface of the pile (110) upward, fix the elastic spring (241) to an upper surface of the housing body (211) via an upper fixing cap (242), and allow a downwardly applied pre-stress (P) to be introduced to the first front expanding anchor (220a) using the injected bonding material (300) as a support.

According to another aspect of the present invention, there is provided a method of constructing an offshore wind power foundation with improved water-tightness includes (a) a step of providing an offshore wind power foundation (100) having a lower end passing through a leg (120) from an upper surface of the leg (120), wherein a first front expanding anchor (220a) is pre-installed at the upper surface of the leg (120) so that an upper end of the offshore wind power foundation (100) is exposed upward, (b) a step of mounting the offshore wind power foundation (100) on a seabed ground by inserting a hollow part of the leg (120) into a head of a pile (110) pre-constructed on a seabed surface and installing an elastic spring unit (240) including an elastic spring (241) having a lower end fixed to an upper surface of the finished pile, (c) a step of setting a precast cap member (200) on an upper surface of the leg (110) by allowing the first front expanding anchor (220a) installed at the upper surface of the leg to pass through the flanges (212) of a precast housing (210) of the precast cap member (200), allowing a second front expanding anchor (220b) to pass through a housing body (211) of the precast housing (210), and allowing an upper end of the elastic spring unit (240) to be set on a lower surface of the center of the housing body (211) of the precast housing (210), (d) a step of injecting a bonding material (300) into a space formed between the precast cap member (200), the pile (100), and the leg (120) through an injection port of the precast cap member (200) using a bonding material rotation-injection port (230) in a state in which a lower plate (242a) integrated with an upper end of the elastic spring (241) extends upward, and (e) a step of increasing a water stopping effect by introducing a pre-stress (P) applied to the first front expanding anchor (220a) downward by re-fastening an upper plate (242c) of the elastic spring unit to an upper surface of the precast cap member (200) using a fixing nut (242d), the upper plate (242c) restraining an elastic spring using the bonding material (300) with secured strength as a support, and compressing the offshore wind power foundation (100) and the pile (110) by allowing the pre-stress (P) to also be introduced to the front expanding anchor (220b).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1A is a construction view of a conventional offshore wind power generator concrete foundation structure;

FIG. 1B shows an example of a grouting material injection unit of the conventional wind power generator concrete foundation structure;

FIGS. 2A and 2B are a perspective view and extracted views of an offshore wind power foundation parts with improved water-tightness of one embodiment of the present invention; and

FIGS. 3A to 3F are a flowchart of a construction method of the offshore wind power foundation with improved water-tightness of one embodiment of the present invention.

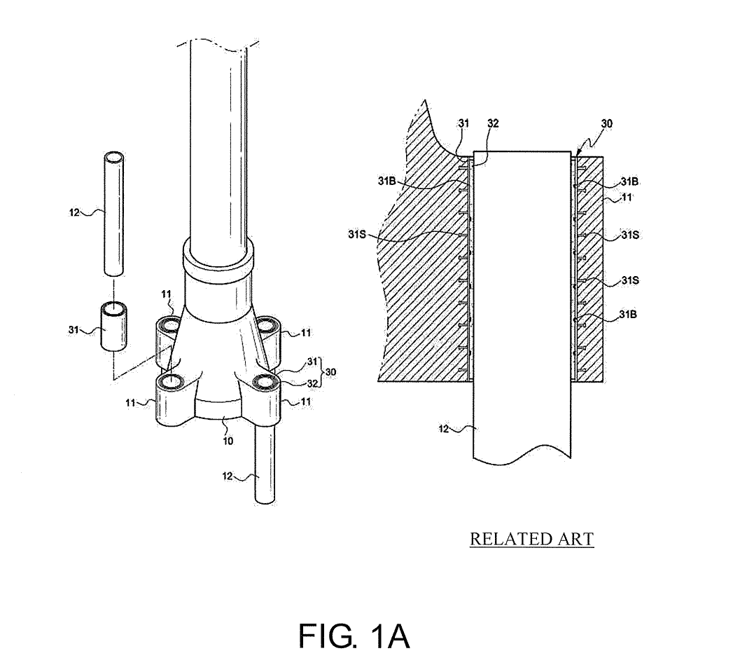

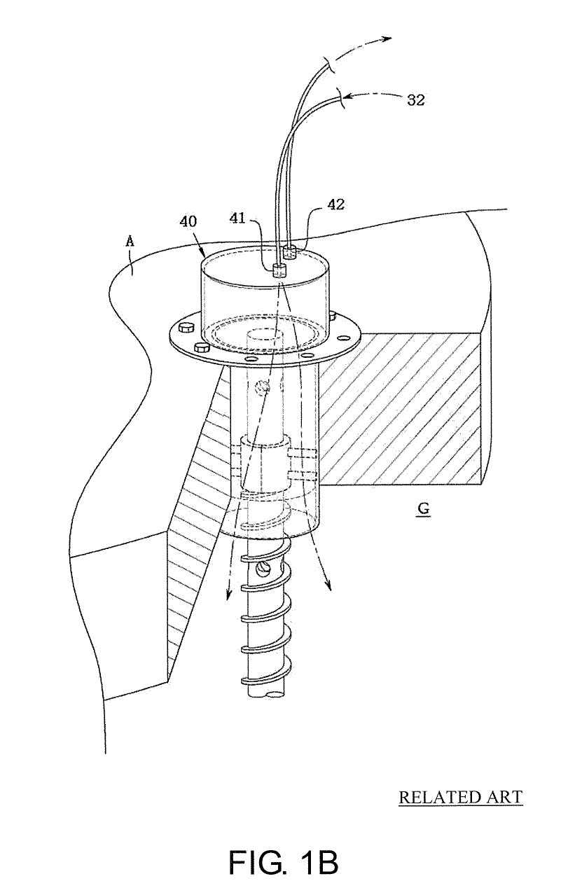

### DETAILED DESCRIPTION OF EXEMPLARY EMBODIMENTS

Hereinafter, embodiments that are easily performed by those skilled in the art will be described in detail with reference to the accompanying drawings. However, the embodiments of the present invention may be implemented in several different forms, and are not limited to embodiments described herein. In addition, parts irrelevant to description will be omitted in the drawings to clearly explain the embodiments of the present invention. Similar parts will be denoted by similar reference numerals throughout this specification.

Throughout the specification, when a portion “includes” an element, the portion may include the element, and another element may be further included therein unless otherwise described.

[Offshore Wind Power Foundation Unit 100 with Improved Water-Tightness of the Present Invention]

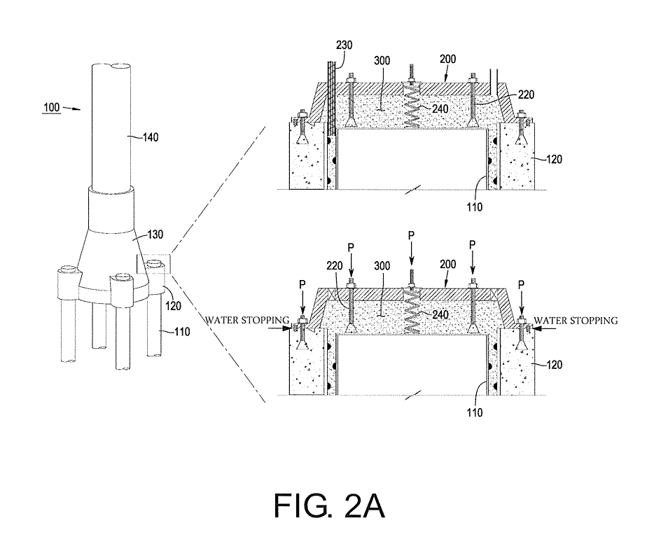

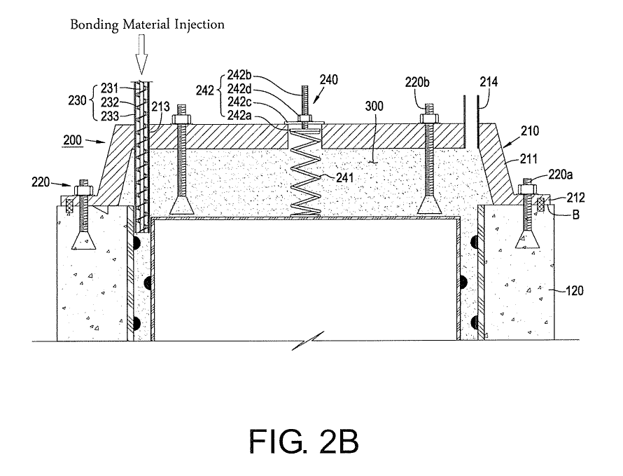

FIGS. 2A and 2B are a perspective view and extracted views of an offshore wind power foundation with improved water-tightness of one embodiment of the present invention.

The offshore wind power foundation 100 includes a pile 110, a foundation 130 with a leg 120, and a column 140, and further includes a precast cap member 200 for injecting a bonding material 300 into an upper surface of the leg 120.

The pile 110 is fixed to the seabed ground through the leg 120 of the offshore wind power foundation 100, may use a steel pile and a concrete pile, and may support the precast cap member 200 through an elastic spring unit 240, which will be described below, by finishing an upper surface as a horizontal surface.

The leg 120 has a vertical hollow shape formed at an outer circumferential surface of the foundation 130, is a member allowing an upper end of the pile 110 to be inserted thereinto from a lower side, and is integrated with the foundation 130.

The foundation 130 includes the leg 120 to be fixed to the seabed ground by the pile 110, and the column 140 (a tower) may be installed above the foundation 130.

A nacelle for an offshore wind power generator and a blade (not shown) are installed at an upper end of the column 140, and a lower end of the column 140 is integrally installed with the foundation 130.

Generally, the nacelle, a blade, and the column refer to an upper structure of the offshore wind power foundation, and the foundation with the leg and the pile is referred to as a lower structure thereof.

In this case, the upper end of the pile 110 is integrated with the leg 120 while being inserted into the leg 120, and thus the upper end of the pile 110 is coupled to the leg 120 using a bonding material 300 (a grouting material) under water.

The bonding material 300 should be injected into a space between an inner surface of the leg and the pile 110 while water-tightness is secured, and the precast cap member 200 of the present invention can sufficiently secure water-tightness and integration (the offshore wind power foundation) of the foundation 130 with the leg 120 and the pile 110 by compressing the pile 110.

As shown in FIGS. 2A and 2B, the precast cap member 200 includes a precast housing 210, front expanding anchors 220 (220a and 220b), a bonding material rotation injection port 230, and an elastic spring unit 240.

As shown in FIGS. 2A and 2B, the precast housing 210 includes a housing body 211 and a flange 212 and has a hat shape, and the flange 212 is supported on an upper surface B of the leg 120.

The precast housing 210 should be manufactured of a steel material, but may be manufactured of precast concrete to secure a weight thereof.

As shown in FIGS. 2A and 2B, the front expanding anchors 220 have a difference between positions, that is, the front expanding anchors 220 are positioned at the upper surface of the leg 120 or the precast housing 210, but the same front expanding anchors 220 are used.

The front expanding anchor 220a installed at the upper surface of the leg 120 passes through the flange 212 of the precast housing 210, and has an upper end fixed to the flange 212 of the precast housing 210 by a fastening member, such as a nut, and a front end formed as an expansion front end with an expanded diameter to be embedded in the leg 120 such that a pull-out force is efficiently resisted.

Next, the front expanding anchor 220b installed in the precast housing passes through the housing body 211 of the precast housing 210 via a fastening port, such as a nut, and has an upper end fixed to the housing body 211 of the precast housing 210 and a front end formed as an expansion front end with an expanded diameter to be embedded in the bonding material 300 injected into the precast housing 210 to be set to be supported by the upper surface of the pile 110.

As shown in FIGS. 2A and 2B, the bonding material rotation injection port 230 is inserted into an injection port 213 so that the bonding material 300 is injected into a space between the pile 110 and the leg 120 and the lower portion of the precast housing 210, and the injection port 213 and a discharge port 214 are formed at the housing body 211 of the precast housing 210.

Since many intervening factors due to water pressure are generated when the bonding material 300 is injected into the space using pumping under water, the bonding material 300 passes through the injection port 213 of the precast housing 210, and the bonding material rotation injection port 230 with an open lower portion is used in the space of the injection port 213.

In this case, the injection port 213 is formed as a hole passing through the housing body 211, and the discharge port 214 is formed as a hole functioning as an observation hole through which observation is performed so that the bonding material 300 may be hermetically injected into the space.

The bonding material rotation injection port 230 includes an inner pipe 231, an outer pipe 233, and an upper fixing cap 242.

First, the outer pipe 231 has a diameter to be inserted into the injection port 213. The bonding material 300 may not be injected when negative pressure is generated when the bonding material 300 is directly injected into the outer pipe 233.

Therefore, the inner pipe 231 having a rotating blade 232 formed at an outer circumferential surface thereof is inserted into the outer pipe 233, and the bonding material 300 is rotation-injected by the rotating blade 232 as the rotating blade 232 is rotated.

Therefore, the bonding material 300 is injected into the inner pipe 231 of the bonding material rotation injection port 230 through a separated pipe.

The elastic spring unit 240 may increase a bonding force of the offshore wind power foundation 100 and the pile 110 by introducing a pre-stress to the front expanding anchors 220a and 220b using the bonding material 300 with strength injected through the precast cap member 200 as a support to increases stability of the structure.

Therefore, as shown in FIGS. 2A and 2B, the elastic spring unit 240 includes an elastic spring 241 and the upper fixing cap 242.

That is, the precast housing 210 has a hat shape and has a through hole formed in the center of the housing body 211 so that an upper end of the elastic spring 241 is inserted through the through hole to be positioned at an upper surface of the housing body 211 by the upper fixing cap 242.

Therefore, the elastic spring 241 may uses a steel spring, and the upper fixing cap 242 includes a lower plate 242a, an upper plate fixing bolt 242b, an upper plate 242c, and a fixing nut 242d that are installed above the elastic spring 241.

That is, the upper plate fixing bolt 242b, the upper plate 242c, and the fixing nut 242d are integrated with the upper end of the elastic spring 241 and are fixed and attached to the housing body 211 of the precast housing 210 and the elastic spring 241.

Therefore, the lower plate 242a is integrated with an upper surface of the elastic spring 241, and the upper plate 242c is fixed to an upper surface of the center of the lower plate 242a and has the upper plate fixing bolt 242b extending upward therethrough.

The upper plate 242c is supported on the upper surface of the housing body 211 of the precast housing 210.

The fixing nut 242d is rotation-fastened to the upper plate fixing bolt 242b and is configured to maintain a state in which the upper plate 242c is pressed onto the upper surface of the housing body 211 of the precast housing 210.

The bonding material 300 is injected into a space between a lower portion of the precast cap member 200 and the pile, and a space between a sleeve, which is a steel plate formed on an inner surface of the leg 120, and the pile 110 by the bonding material rotation injection port 230 of the precast cap member 200 fixed to an upper surface of the leg 120, and uses a grouting material.

The bonding material 300 is injected through the injection port by the bonding material rotation injection port 230, and is injected using pressure and rotation.

[Method of Constructing Offshore Wind Power Foundation 100 with Improved Water-Tightness]

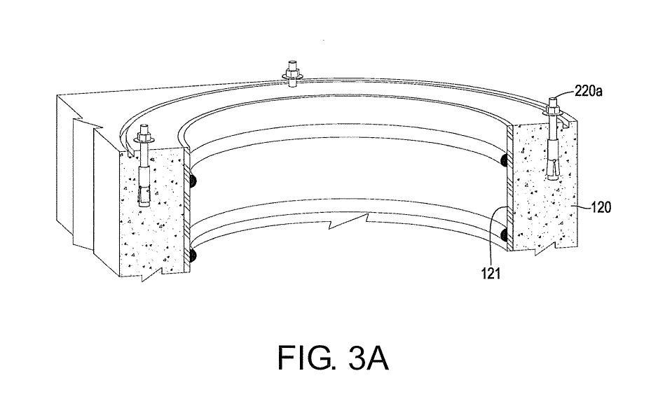

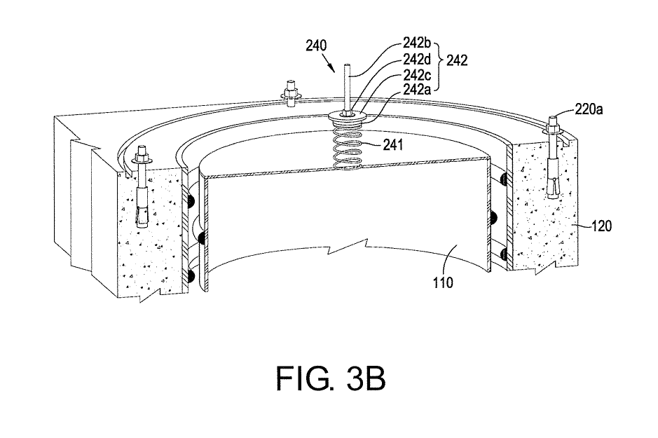

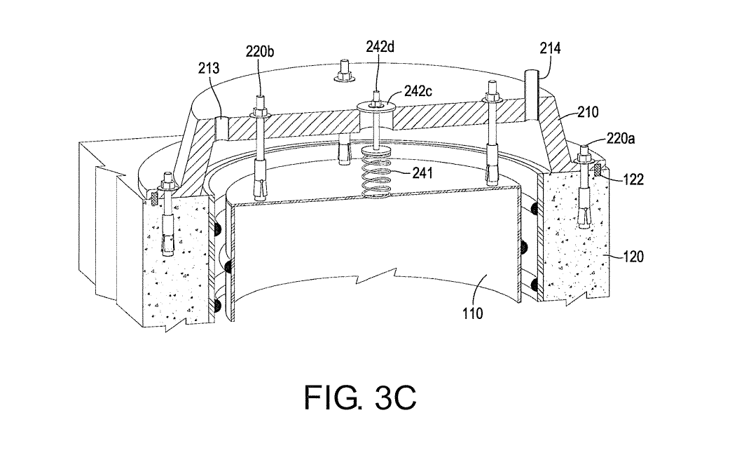

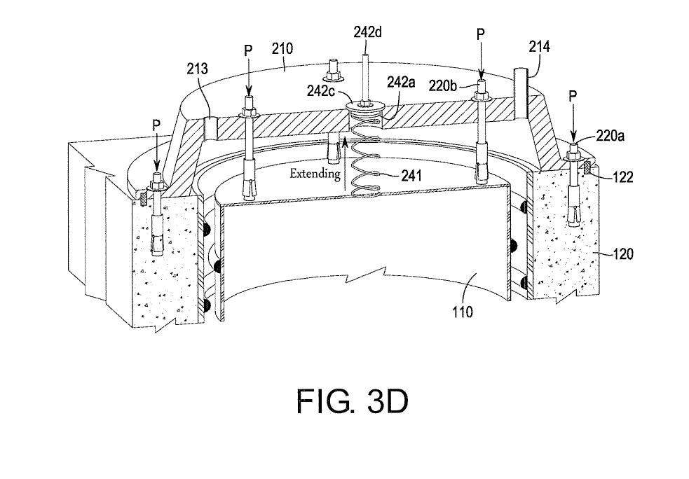

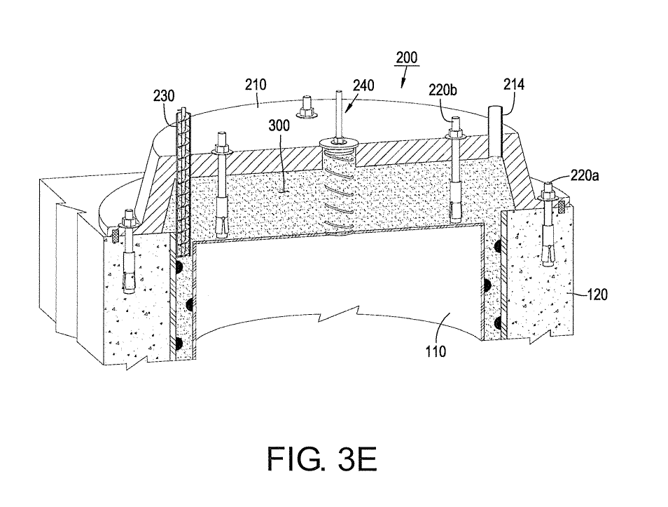

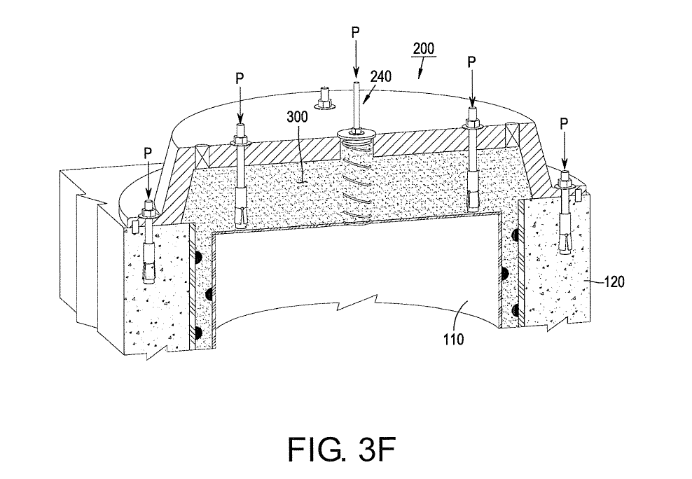

FIGS. 3A to 3F are a flowchart of a construction method of the offshore wind power foundation with improved water-tightness of one embodiment of the present invention.

The offshore wind power foundation 100 pre-manufactured on the ground is constructed so that an upper end of the pile 110 pre-constructed at a position to be constructed using a barge and the like is inserted into the leg 120, a tower of the offshore wind power foundation 100 extends above a sea surface, and a nacelle and blade are installed at an upper end of the tower.

The present invention will be described on the basis of the pile 110, the leg 120, the precast cap member 200, and the bonding material 300.

First, as shown in FIG. 3A, the front expanding anchor 220a is pre-installed at the leg 120 of the offshore wind power foundation 100 pre-manufactured on the ground.

A lower end of the front expanding anchor 220a installed at an upper surface of the leg is installed to pass through the leg from an upper surface of the leg 120, and an upper end to the front expanding anchor 220a is exposed upward.

Further, the sleeve 121 is formed at an inner surface of a hollow part of the leg 120, and a protrusion is further formed on the sleeve 121 such that synthetic performance with the bonding material 300 can be secured.

Next, as shown in FIG. 3B, in the offshore wind power foundation 100 transferred to the sea, a hollow part of the leg 120 is inserted into a head of the pile 110 pre-installed on the seabed ground, and the offshore wind power foundation 100 is finally seated on the seabed ground. Therefore, an upper surface of the pile 110 is seated to be almost in line with an upper surface of the leg 120.

Therefore, since the upper surface of the pile 110 is finished, the elastic spring unit 240 is installed. That is, a lower end of the elastic spring unit 240 is set to be supported and fixed to the upper surface of the pile 110.

That is, the lower plate 242a is integrated with an upper surface of the elastic spring 241, the upper plate fixing bolt 242b extending from an upper surface of the center of the lower plate 242a passes through the upper plate 242c, and the fixing nut 242d is rotation-fastened to the upper plate fixing bolt 242b.

Next, as shown in FIG. 3C, the precast housing 210 of the precast cap member 200 is set on the upper surface of the leg 120.

That is, the front expanding anchor 220a installed at an upper surface of the leg passes through the flange 212 of the precast housing 210 constituting the precast cap member 200.

The front expanding anchor 220b passes through the through hole formed at the housing body 211 of the precast housing 210, and a front end thereof is supported at the upper surface of the pile.

The upper plate 242c and the upper plate fixing bolt 242b of the elastic spring unit 240 are inserted from a bottom of the through hole formed in the center of the housing body 211 of the precast housing 210 into the through hole, and the upper plate 242c is set to be supported at an upper surface of the center of the housing body 211.

In this case, the flange 212 of the precast housing 210 secures water-tightness of the inner space of the precast cap member 200 using a water stopping material 122, which is not shown, on the upper surface of the leg 120, and an uneven part with or instead of the water stopping material 122 may be formed at the upper surface of the leg and the flange 212 to improve water stopping functionality.

Also, the injection port 213 and the discharge port 214 are formed at the housing body 211 of the precast housing 210.

Next, as shown in FIG. 3D, the lower plate 242a integrated with an upper end of the elastic spring 241 extends upward. That is, the upper plate fixing bolt 242b fixed to the upper surface of the center of the lower plate 242a extends upward by unfastening the fixing nut 242d, and the lower plate and the elastic spring 241 extend.

Next, as shown in FIG. 3E, the bonding material 300 is injected in a state in which the lower plate 242a extends upward.

Water-tightness of the precast cap member 200 is secured by the water stopping material 122, and thus the bonding material 300 may be injected without an effect of a tide and the like at a still-water level.

The bonding material 300 is integrated with the precast cap member 200, the pile 110, and the leg 120 as a grouting material and, as described above, is hermetically injected into a space between an inner surface of the leg 120 and an outer surface of the pile 110, and a space between the precast cap member 200 and the upper surface of the pile using the bonding material rotation injection port 230 including the outer pipe 233, the inner pipe 231, and the upper fixing cap 242.

As shown in FIG. 3F, when the bonding material 300 has sufficient strength (curing), the fixing nut 242d is set so that the upper plate 242c is supported on the upper surface of the center of the housing body 211 using the bonding material 300 as a support. Therefore, the front expanding anchor 220a allowing a downwardly applied pre-stress to be introduced such that a water stopping effect is further increased. A pre-stress P is also introduced to the front expanding anchor 220b so that the offshore wind power foundation 100 and the pile 110 are efficiently compressed (increase bonding).

Therefore, when the bonding material 300 is finally cured, the precast cap member 200, the leg 120, and the pile 110 are efficiently integrated and compressed, and the injection port and the discharge port are finished.

Although not shown, the tower is installed at the offshore wind power foundation 100, and the nacelle and the blade are mounted at the upper portion of the exposed tower so that the offshore wind power generator may be constructed.

According to the offshore wind power foundation with improved water-tightness and a construction method thereof, a precast cap member is installed at a pile and an upper end of an offshore wind power foundation bonding part to maintain a stillwater level, and thus prevents a bonding material from being lost due to a tide.

Further, the precast cap material functioning as a conventional guide pipe cap is installed to block a tide and the bonding material from coming into direct contact, and thus prevents the bonding material from being lost and prevents contamination caused by leakage of the bonding material.

Further, after a front expanding anchor is installed in the offshore wind power foundation and the pile and the bonding material (the grouting material) is prepared, a pre-stress is introduced to the front expanding anchor using the precast cap member as a support to increase a bonding force of the offshore wind power foundation and the pile and increase stability of a structure.

Further, the elastic spring unit is installed at an upper end of the pile, a bonding material is prepared in a state in which an elastic spring installed at an upper end of the pile extends using the precast cap member as a support, and a tensile force introduced to the elastic spring unit is released when the bonding material exerts sufficient strength so that the pre-stress introduced to the offshore wind power foundation and the pile is introduced to increase a bonding force of the offshore wind power foundation and the pile and increase stability of the structure.

Further, an inner pipe and outer pipe separation-type bonding material rotation injection port having a rotating blade attached to the inside of the outer pipe is installed and the bonding material is injected via the rotating blade when a bonding material is injected, thereby preventing material separation due to freefall and hermetically pouring the bonding material so that quality of the bonding material can be secured.

Further, an observation port, which is an injection port and a discharge port is installed at an upper portion of the precast cap member to allow a condition of the filled bonding material to be directly checked such that construction and management of the bonding material can be easy and quality of the bonding material can be secured.

Further, an uneven part or a water stopping material is installed at an upper surface of the precast cap member and the offshore wind power foundation to secure water-tightness of a contact surface between the precast cap member and the offshore wind power foundation such that water-tightness can be increased.

The above description is only exemplary, and it should be understood by those skilled in the art that the invention may be performed in other concrete forms without changing the technological scope and essential features. Therefore, the above-described embodiments should be considered only as examples in all aspects and not for purposes of limitation. For example, each component described as a single type may be realized in a distributed manner, and similarly, components that are described as being distributed may be realized in a coupled manner.

The scope of the present invention is defined not by the detailed description but by the appended claims, and encompasses all modifications or alterations derived from meanings, the scope, and equivalents of the appended claims.

What is claimed is:

1. An offshore wind power foundation with improved water-tightness, configured such that a bonding material is injected into a space between a pile and a leg using a precast cap member to integrate the leg and the pile, wherein the precast cap member comprising:
a precast housing, comprising flanges fixed to an upper surface of the leg by a first front expanding anchor and a housing body formed between the flanges;
a bonding material rotation injection port, being an inner pipe having a rotating blade inserted into an outer pipe and formed at an outer circumferential surface of the inner pipe, wherein the bonding material is rotation-injected into the space between the pile and the leg through the injection port formed in the housing body via the rotating blade; and
an elastic spring unit, configured to extend an elastic spring installed between the housing body of the precast housing and an upper surface of the pile upward, fix the elastic spring to an upper surface of the housing body via an upper fixing cap, and allow a downwardly applied pre-stress to be introduced to the first front expanding anchor using the injected bonding material as a support.

2. The offshore wind power foundation of claim 1, wherein the precast housing further comprises a second front expanding anchor between the housing body and the upper surface of the pile to integrate the pile and the offshore wind power foundation via the downwardly applied pre-stress due to the elastic spring using the bonding material injected into the precast housing and the pile.

3. The offshore wind power foundation of claim 1, wherein the flanges of the precast housing are configured to secure water-tightness of an inner space of the precast cap member using an uneven part or a water stopping material on the leg in addition to the pre-stress introduced to the first front expanding anchor.

4. The offshore wind power foundation of claim 1, wherein:
the elastic spring unit includes the elastic spring set so that an upper end of the elastic spring unit is inserted into a through hole formed in the housing body of the precast housing and the upper fixing cap formed at the upper surface of the housing body; and
the upper fixing cap includes a lower plate integrated with an upper surface of the elastic spring, an upper plate fixed to an upper surface of the center of the lower plate and having an upper plate fixing bolt extending upward and passing therethrough, and a fixing nut rotation-fastened to the upper plate fixing bolt and configured to maintain a state in which the upper plate is pressed onto the upper surface of the housing body of the precast housing.

5. A method of constructing an offshore wind power foundation with improved water-tightness, the method comprising:
(a) a step of providing an offshore wind power foundation having a lower end passing through a leg from an upper surface of the leg, wherein a first front expanding anchor is pre-installed at the upper surface of the leg so that an upper end of the offshore wind power foundation is exposed upward;
(b) a step of mounting the offshore wind power foundation on a seabed ground by inserting a hollow part of the leg into a head of a pile pre-constructed on a seabed surface and installing an elastic spring unit including an elastic spring having a lower end fixed to an upper surface of the finished pile;
(c) a step of setting a precast cap member on an upper surface of the leg by allowing the first front expanding anchor installed at the upper surface of the leg to pass through flanges of a precast housing of the precast cap member, allowing a second front expanding anchor to pass through a housing body of the precast housing, and allowing an upper end of the elastic spring unit to be set on a lower surface of the center of the housing body of the precast housing;
(d) a step of injecting a bonding material into a space formed between the precast cap member, the pile, and the leg through an injection port of the precast cap member using a bonding material rotation-injection port in a state in which a lower plate integrated with an upper end of the elastic spring extends upward; and
(e) a step of increasing a water stopping effect by introducing a pre-stress applied to the first front expanding anchor downward by re-fastening an upper plate of the elastic spring unit to an upper surface of the precast cap member using a fixing nut, the upper plate restraining an elastic spring using the bonding material with secured strength as a support, and compressing the offshore wind power foundation and the pile by allowing the pre-stress to also be introduced to the second front expanding anchor.

6. The method of claim 5, wherein the precast cap member in step (c) comprises:
the precast housing, including the flanges fixed to the upper surface of the leg by the first front expanding anchor and the housing body formed between the flanges;
the bonding material rotation injection port, being an inner pipe having an outer circumferential surface at which a rotating blade inserted into an outer pipe is formed; and
the elastic spring unit, configured to extend the elastic spring installed between the housing body of the precast housing and an upper surface of the pile upward, fix the elastic spring to an upper surface of the housing body via an upper fixing cap, and allow the downwardly applied pre-stress to be introduced to the first front expanding anchor using the injected bonding material as a support.

7. The method of claim 6, wherein:
in the step (c), the pre-stress of step (e) extends the lower plate integrated with the upper end of the elastic spring upward and extends the lower plate and the elastic spring by extending an upper plate fixing bolt, which is fixed to an upper surface of the center of the lower plate, upward by the fixing nut being unfastened; and
in the step (d), the pre-stress couples the upper plate of the elastic spring unit configured to restrain the elastic spring using the injected bonding material with secured strength as a support to the upper surface of the precast cap member by the fixing nut to introduce the downwardly applied pre-stress to the first front expanding anchor.

8. The method of claim 7, wherein:
the elastic spring unit in the step (c) comprises the elastic spring having an upper end inserted into a through hole formed on the housing body of the precast housing, and an upper fixing cap formed at the upper surface of the housing body; and
the upper fixing cap comprises the lower plate integrated with an upper surface of the elastic spring, the upper plate fixed to the upper surface of the center of the lower plate and the upper plate fixing bolt extending upward and passing therethrough, and the fixing nut configured to be rotation-fastened to the upper plate fixing bolt and maintain a state in which the upper plate is pressed onto the upper surface of the housing body of the precast housing.

9. The method of claim 5, wherein the bonding material rotation-injection port in the step (d) is an inner pipe having an outer circumferential surface to which a rotating blade inserted into an outer pipe is formed, and allows the bonding material to be rotation-injected into a space between the pile and the leg through an injection port formed in the housing body by the rotating blade.

10. The method of claim 5, wherein:
in the step (d), whether the bonding material is injected is measured through a discharge port formed in the precast cap member; and
in the precast housing of the precast cap member, the flanges secure water-tightness of an inner space of the precast cap member by using a water stopping material or an uneven part on the upper surface of the leg.
